(19) United States
(12) Patent Application Publication
(10) Pub. No.: US 2021/0049025 A1
(43) Pub. Date: Feb. 18, 2021

(54) ELECTRONIC APPARATUS AND OBJECT SHARING METHOD THEREOF

(71) Applicant: XRSPACE CO., LTD., Taoyuan City (TW)

(72) Inventor: Chi-Yang Huang, Tainan City (TW)

(73) Assignee: XRSPACE CO., LTD., Taoyuan City (TW)

(21) Appl. No.: 17/089,731

(22) Filed: Nov. 5, 2020

Related U.S. Application Data
(63) Continuation-in-part of application No. 16/386,281, filed on Apr. 17, 2019.

(51) Int. Cl. G06F 9/445; G06F 8/61

(52) U.S. Cl. CPC G06F 9/44563; G06F 8/61

(57) ABSTRACT

An electronic apparatus and an object sharing method thereof. In the method, An operating system (OS) determines a common object used by two or more applications. The objects of the applications are downloaded into a library in response to the installations of the application, respectively. The common object is one of the objects of the applications. The OS stores the common object into a shared memory from the library. The OS changes the access destination of the first application of the applications from the library into the shared memory, to access the common object from the shared memory by the first application based on the access destination of the first application. Therefore, the efficiency of accessing the object and memory usage can be improved.

### CROSS-REFERENCE TO RELATED APPLICATION

This application is a continuation-in-part application of and claims the priority benefit of U.S. application Ser. No. 16/386,281, filed on Apr. 17, 2019, now pending. The entirety of the above-mentioned patent application is hereby incorporated by reference herein and made a part of this specification.

### BACKGROUND OF THE DISCLOSURE

### 1. Field of the Disclosure

The present disclosure generally relates to object management, in particular, to an electronic apparatus and an object sharing method thereof.

### 2. Description of Related Art

An operator of an electronic apparatus (for example, a smartphone or a head-mounted display) usually launches a system development kit (SDK) for the developers to create their applications compatible with the electronic apparatus. In these applications, some software assets are similar or substantially the same.

There are two known methods for managing software assets. The first known method is building the same software assets into individual applications before these applications are downloaded or updated. In detail, when an application or an updated version of the application is released, all related software assets are already built into the application or the updated version of the application. Then, the application can be launched in an application store platform for users to download or update. However, different applications using the same software assets have the same software assets (for example, a virtual tree, car, etc.), and result in a large size of each application.

The second known method is loading software assets into a memory of the electronic apparatus repeatedly for different applications. For example, when two different applications need the same software asset in the electronic apparatus, it would load the same software asset to the memory twice. That is, the memory of the electronic apparatus may store N software assets, which are substantially the same, for N different applications, where N is an integer.

Both the first and second known methods cause large data transmission and space usage of the memory. Therefore, the electronic apparatus may spend a lot of time for data transmission, and the operating system (OS) performance may go down because of too many data accesses. Furthermore, the network bandwidth of the network provider may always be occupied by the transmission of the software assets.

### SUMMARY OF THE DISCLOSURE

Accordingly, the present disclosure is directed to an electronic apparatus and an object sharing method thereof, to improve memory usage and access efficiency.

In one of the exemplary embodiments, the object sharing method is adapted for managing objects and includes, but is not limited to, the following steps. An operating system (OS) determines a common object used by two or more applications. The objects of the applications are downloaded into a library in response to the installations of the application, respectively. The common object is one of the objects of the applications. The OS stores the common object into a shared memory from the library. The OS changes the access destination of the first application of the applications from the library into the shared memory, to access the common object from the shared memory by the first application based on the access destination of the first application.

In one of the exemplary embodiments, the electronic apparatus includes, but is not limited to, a memory and a processor. The memory stores program code and comprises a library and a shared memory. The objects of two applications are downloaded into the library in response to installations of the applications, respectively. The processor is coupled to the memory. The processor loads and executes the program code to perform the following steps. An OS determines a common object used by two or more applications. The common object is one of the objects of the applications. The OS stores the common object into a shared memory from the library. The OS changes the access destination of the first application of the applications from the library into the shared memory, to access the common object from the shared memory by the first application based on the access destination of the first application.

It should be understood, however, that this Summary may not contain all of the aspects and embodiments of the present disclosure, is not meant to be limiting or restrictive in any manner, and that the invention as disclosed herein is and will be understood by those of ordinary skill in the art to encompass obvious improvements and modifications thereto.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a block diagram illustrating a system according to one of the exemplary embodiments of the disclosure.

FIG. 2 is a flowchart illustrating an object sharing method of an electronic apparatus according to one of the exemplary embodiments of the disclosure.

FIG. 3 is a flowchart illustrating an object installation of the electronic apparatus according to one of the exemplary embodiments of the disclosure.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

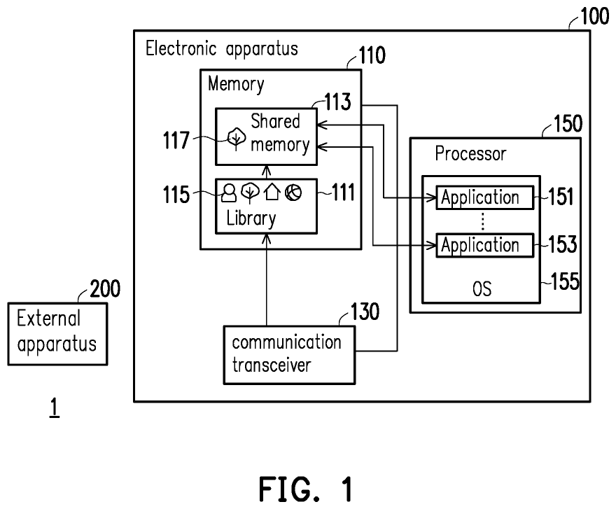

FIG. 1 is a block diagram illustrating a system 1 according to one of the exemplary embodiments of the disclosure. Referring to FIG. 1, the system 1 includes, but is not limited to, one or more electronic apparatuses 100 and one or more external apparatuses 200.

The electronic apparatuses 100 could be a smartphone, a tablet, a head-mounted display, a smart TV, a desktop computer, a laptop, or other computing devices. The electronic apparatus 100 includes, but is not limited to, a memory 110, a communication transceiver 130, and a processor 150.

The memory 110 may be any type of a fixed or movable random-access memory (RAM), a read-only memory (ROM), a flash memory, a similar device, or a combination of the above devices. The memory 110 includes, but is not limited to, a library 111 and a shared memory 113.

In one embodiment, the library 111 can be stored in a volatile memory or a non-volatile memory. For example, the non-volatile memory can be a ROM, a flash memory, a hard disk, a disc, or a tape. In another embodiment, the shared memory 113 is a volatile memory, for example, a RAM, where the RAM can be a dynamic random-access memory (DRAM) or a static random-access memory (SRAM). In contrast to non-volatile memory, the volatile memory is computer memory that requires power to maintain the stored information. That is, the volatile memory retains its contents while powered on but may quickly lose its stored data when the power is interrupted.

In some embodiments, the memory 110 stores program codes, software modules (such as applications 151 and 153), an operating system 155, device configurations, buffer data, or permanent data (such as objects, priority, or lists), and these data would be introduced later.

The communication transceiver 130 could be a communication interface or a wireless transceiver that supports, for example, Bluetooth, Wi-Fi, mobile communication, IR wireless communication, USB, Ethernet, fiber network, etc. In some embodiments, the communication transceiver 130 is used to communicate with the external apparatus 200, so as to receive data from the external apparatus 200 or transmit data to the external apparatus 200.

The processor 150 is coupled to the memory 110 and the communication transceiver 130. The processor 150 is configured to load the program codes stored in the memory 110, to perform a procedure of the exemplary embodiment of the disclosure.

In some embodiments, the processor 150 may be a central processing unit (CPU), a microprocessor, a microcontroller, a digital signal processing (DSP) chip, a field-programmable gate array (FPGA). The functions of the processor 150 may also be implemented by an independent electronic device or an integrated circuit (IC), and operations of the processor 150 may also be implemented by software.

The external apparatus 200 could be a smartphone, a tablet, a server, a desktop computer, a laptop, a universal serial bus (USB) hard disk, a USB flash, etc.

To better understand the operating process provided in one or more embodiments of the disclosure, several embodiments will be exemplified below to elaborate the operating process of the system 1. The devices and modules in the system 1 are applied in the following embodiments to explain the object sharing method of the electronic apparatus 100 provided herein. Each step of the method can be adjusted according to actual implementation situations and should not be limited to what is described herein.

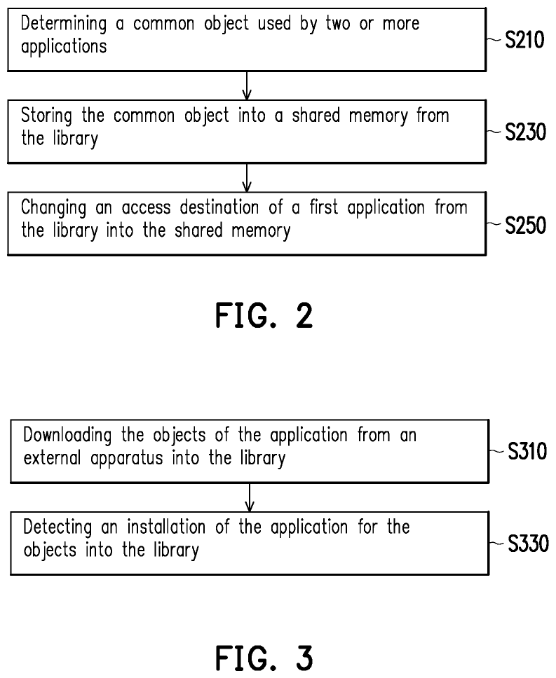

FIG. 2 is a flowchart illustrating an object sharing method of the electronic apparatus 100 according to one of the exemplary embodiments of the disclosure. Referring to FIG. 2, the processor 150 may determine a common object used by two or more applications 151 and 153 through the OS 155 (step S210). Specifically, there are two or more applications 151 and 153 installed in the electronic apparatus 100. In one embodiment, the applications 151 and 153 are related to extended reality (XR) such as virtual reality (VR), augmented reality (AR), and mixed reality (MR). In some embodiments, applications 151 and 153 are related to a two-dimensional (2D) or three-dimensional (3D) environment simulation. It should be noticed that to establish a 2D or 3D environment or 2D or 3D virtual object, 2D or 3D materials such as metals, avatars, fabrics, buildings, roads, or trees would be needed. In one embodiment, object 115 could the 2D or 3D material. In some embodiments, object 115 could be any software asset used by the applications 151 and 153.

At first, corresponding objects 115 of the applications 151 and 153 are downloaded into the library 111 in response to installations of the applications 151 and 153, respectively. For example, FIG. 3 is a flowchart illustrating an object installation of the electronic apparatus 100 according to one of the exemplary embodiments of the disclosure. Referring to FIG. 3, when a complete installation or partial installation of the application 151 or 153 is launched, for example, installing the application 151 or 153, updating another version of the application 151 or 153, or updating data of the application 151 or 153, the OS 155 may download corresponding object 115 of the application 151 or 153 from the external apparatus 200 into the library 111 through the communication transceiver 130, so as to store the object 115 in the library 111 (step S310). For example, a material asset web store is operated on the external apparatus 200, and the electronic apparatus 100 downloads the object 115 in the web store via the Internet.

In one embodiment, the external apparatus 200 may periodically update the library 111 with new objects 115 and renewed objects 115. Therefore, the issues in library 111 may be fixed.

In another embodiment, the library 111 may can be disposed in the external apparatus 200, rather than the electronic apparatus 100.

In some embodiments, the OS 155 may further perform an identity check on object 115 of the application 151 or 153 downloaded into the library 111 from the external apparatus 200. The identity check may be related to password, certificate, secure key, or other identity authentication. If the identity check is passed, object 115 can be stored in library 111. However, if the identity check is not passed, object 115 would be dropped or deleted from memory 110.

Then, the OS 155 may detect the installation of the application 151 or 153 for the object 115 into the library 111 (step S330). For example, the OS 155 may monitor the variation in the memory 110 or the installation process of the application 151 or 153. However, before the application 151 or 153 is launched or executed, the OS 155 may compare whether there are one or more common objects 117 among the applications 151 and 153, and determine the common object 117 in response to the installation of the application 151 or 153 for the objects 115. That is, the installation of the object 115 may trigger the determination of the common object 117.

The common object 117 is one of the objects 115 of the applications 151 and 153. That is, the common object 117 is a duplicated object used by two or more of the applications 151 and 153. It should be noticed that the number of common objects 117 may be more than one. That is, there are two or more duplicated objects used by two or more applications 151 and 153.

In one embodiment, the OS 155 may create a global object list, where all of the objects 115 of the applications 151 and 153 are listed in the global object list. For example, in response to the installation of object 115 in library 111, the OS 155 further records which object 115 is installed. The name or identity of the object 115 would be recorded in the global object list. Furthermore, the OS 155 may select one or more duplicated objects in the global object list as the common object(s) 117 into a shared list from the global object list, so that the common object(s) 117 would be listed in the shared list.

In one embodiment, in response to an updating or a newly downloading of the object 115 of the application 151 or 153, the OS 155 may compare the object 115 of the application 151 or 153 with all objects 115 of the global object list. If the newly added or updated object 115 is the same as the objects 115 recorded in the global object list, the OS 155 would consider the newly added or updated object 115 as the common object 117 and record it in the shared list.

In some embodiments, the number of objects listed in the shared list is limited by a number threshold, such as 20, 50, or 100. The number threshold may be related to the overall size of all listed objects and/or the size of the shared memory 113. Furthermore, the OS 155 may configure each common object 117 with a corresponding priority. The priority may be related to the duplicated number among all of the applications 151 and 153, access requirement, or other conditions. For example, in a meeting scene, an avatar has a higher priority, and a virtual ball has a lower priority. If the number of objects listed in the shared list exceeds the number threshold, the OS 155 may remove the common object 117 from the shared list based on the corresponding priority. For example, the common object 117 having the lowest priority would be removed from the shared list first, and the common object 117 having higher priority would be still in the shared list.

The processor 150 may store the common object 117 into the shared memory 113 from the library 111 through the OS 155 (step S230). Specifically, the OS 155 may preload the object 115, which has been considered as the common object 117, from the library 111 to the shared memory 113 before the application 151 or 153 requires for any object 115. In one embodiment, the OS 155 may copy the common object 117 recorded in the shared list to the shared memory 113 after the electronic apparatus 100 is booted or rebooted. In another embodiment, the shared memory 113 preloads the common object 117 when the application 151 or 153 requires any object 115.

The processor 150 may change the access destination of the application 151 or 153 from the library 111 into the shared memory 113 through the OS 155 (step S230). Specifically, when the application 151 or 153 is executed, instead of accessing the common object 117 from the library 111, the application 151 or 153 would access the common object 117 from the shared memory 113. That is, the access destination of the common object 117 would be modified as the shared memory 113. In one embodiment, the access destination of the objects 115 is configured according to the shared list. For example, the object 155 recorded in the shared list would be configured with the access destination as the shared memory 113. Then, the application 151 or 153 can access the common object 117 from the shared memory 113 based on the access destination of the application 151 or 153.

Comparing with the conventional approaches, there is no need for individual applications to access any common object 117 from the library 111. Furthermore, the common object 117 can be accessed by the applications 151 and 153 from the shared memory 113 simultaneously. Therefore, the access time of the applications 151 and 153 for completely accessing the common object 117 can be reduced.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. An object sharing method, adapted for managing objects, and the object sharing method comprising:
determining, by an operating system (OS), a common object used by at least two applications, wherein objects of the at least two applications are downloaded into a library in response to installations of the at least two applications respectively, and the common object is one of the objects of the at least two applications;
storing, by the OS, the common object into a shared memory from the library; and
changing, by the OS, an access destination of a first application of the at least two applications from the library into the shared memory, to access the common object from the shared memory by the first application based on the access destination of the first application.

2. The object sharing method according to claim 1, wherein the step of determining the common object used by the at least two applications comprises:
creating, by the OS, a global object list, wherein all of the objects of the at least two applications are listed in the global object list; and
selecting, by the OS, a duplicated object as the common object into a shared list from the global object list, wherein the common object is listed in the shared list.

3. The object sharing method according to claim 2, wherein the step of determining the common object used by the at least two applications comprises:
comparing, by the OS, objects of a second application of the at least two applications with all objects of the global object list.

4. The object sharing method according to claim 2, further comprising:
configuring, by the OS, the common object with a corresponding priority; and
removing, by the OS, the common object from the shared list based on the corresponding priority in response to a number of objects listed in the shared list exceeding a number threshold.

5. The object sharing method according to claim 1, wherein the step of determining the common object used by the at least two applications comprises:
detecting, by the OS, the installation of the first application for the objects into the library; and
determining, by the OS, the common object in response to the installation of the first application for the objects.

6. The object sharing method according to claim 1, wherein the common object is a two-dimensional or three-dimensional material used in an extended reality (XR).

7. The object sharing method according to claim 1, further comprising:
downloading the objects of the first applications from an external apparatus into the library.

8. An electronic apparatus, adapted for managing objects, and the electronic apparatus comprising:
a memory, storing program code, and comprising a library and a shared memory, wherein objects of at least two applications are downloaded into the library in response to installations of the at least two applications respectively; and
a processor, coupled to the memory, and loading and executing the program code to perform:
determining, by an operating system (OS), a common object used by the at least two applications, wherein the common object is one of the objects of the at least two applications;
storing, by the OS, the common object into a shared memory from the library; and
changing, by the OS, an access destination of a first application of the at least two applications from the library into the shared memory, to access the common object from the shared memory by the first application based on the access destination of the first application.

9. The electronic apparatus according to claim 8, wherein the processor is further configured to perform:
creating, by the OS, a global object list, wherein all of the objects of the at least two applications are listed in the global object list; and
selecting, by the OS, a duplicated object as the common object into a shared list from the global object list, wherein the common object is listed in the shared list.

10. The electronic apparatus according to claim 9, wherein the processor is further configured to perform:
comparing, by the OS, objects of a second application of the at least two applications with all objects of the global object list.

11. The electronic apparatus according to claim 9, wherein the processor is further configured to perform:
configuring, by the OS, the common object with a corresponding priority; and
removing, by the OS, the common object from the shared list based on the corresponding priority in response to a number of objects listed in the shared list exceeding a number threshold.

12. The electronic apparatus according to claim 8, wherein the processor is further configured to perform:
detecting, by the OS, the installation of the first application for the objects into the library; and
determining, by the OS, the common object in response to the installation of the first application for the objects.

13. The electronic apparatus according to claim 8, wherein the common object is a two-dimensional or three-dimensional material used in an extended reality (XR).

14. The electronic apparatus according to claim 8, further comprising:
a communication transceiver, coupled to the processor and the memory, wherein the processor is further configured to perform:
downloading, through the transceiver, the objects of the first applications from an external apparatus into the library.
